(19) United States
(12) Patent Application Publication
(10) Pub. No.: US 2002/0010689 A1
(43) Pub. Date: Jan. 24, 2002

(54) Method and system for generating and transmitting electronic shipping return labels

(76) Inventors: Andrew Tibbs, Marietta, GA (US); Alan Amling, Marietta, GA (US); David Gittings, Roswell, GA (US); Ross McCullough, Brussels (BE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/853,259

(22) Filed: May 11, 2001

Related U.S. Application Data
(60) Provisional application No. 60/204,651, filed on May 17, 2000.

(51) Int. Cl. G07B 17/02

(52) U.S. Cl. 705/408

(57) ABSTRACT

The present invention comprises systems and methods for generating and providing an electronic return shipping label to a customer to allow the customer to return goods to a merchant or vendor.

### CROSS-REFERENCE TO RELATED APPLICATIONS

This application claims the benefit of priority from the U.S. provisional application No. 60/204,651, filed on May 17, 2000 and entitled “Method and System For Generating And Transmitting Electronic Mailing Return Labels,” the entire contents of which is hereby incorporated by reference.

### FIELD OF THE INVENTION

The present invention is a method and system that uses a networked computer environment, such as the Internet, to generate and send a return shipping label to a customer.

### BACKGROUND OF THE INVENTION

A typical return transaction involves a customer contacting a merchant, via email or phone, to inform the merchant about an item that the customer wishes to return. After approving the return, the merchant obtains a return shipping label from a shipping carrier and mails the return shipping label to the customer, along with any special instructions on how to package the item that is being returned. The customer then prepares the package, affixes the return shipping label to the package and ships the package to the merchant.

The typical return process results in several delays. FIG. 1 illustrates some of these and, in particular, shows that it generally takes a merchant between three and six days to obtain a return shipping label and send it to the customer. In addition, the process described above is manpower intensive in that it requires that a merchant have employees available to receive the return request, approve the return request, and to obtain and send a return shipping label to the customer.

Thus, an unsatisfied need exists for an improved method and system for handling product returns that overcomes deficiencies in the prior art, some of which are discussed above.

### SUMMARY OF THE INVENTION

The present invention comprises systems and methods for generating and providing an electronic return shipping label to a customer to allow the customer to return goods to a merchant or vendor.

In accordance with an embodiment of the present invention, a method is described for a merchant to provide an electronic shipping label to a customer to allow the customer to return goods. In accordance with one aspect of the present invention a return request is received from the customer, shipping information related to the return request is obtained and a return shipping label is generated that can be printed and affixed to a package for the return of the goods. In one described embodiment, the customer submits the return request through a merchant website. In accordance with another embodiment, a customer submits the return request by contacting a merchant representative and the representative submits the return request through the merchant website.

In accordance with another aspect of the invention, shipping information related to the return request includes a customer address and information related to the size and weight of the goods that are being returned. Another aspect of the invention has at least a portion of the shipping information obtained from a customer order database. According to yet another aspect of the present invention, a portion of the shipping information is obtained from a product database.

In an embodiment of the present invention, the return shipping label is formatted as an HTML document and the shipping label is provided to the customer by providing the customer with a URL address that corresponds to the return shipping label. In another embodiment, a customer is provided with a file containing an electronic image of the return shipping label. In still another embodiment, a return shipping label is sent to a carrier with instructions to pick up the goods from the customer's address.

In accordance with another embodiment of the present invention, a method is disclosed to provide an electronic return shipping label to a customer to allow the customer to return goods. The disclosed method comprises the steps of receiving a return request for the goods from the customer, obtaining shipping information related to the return request, transmitting the shipping information to an application service provider, the application service provider configured to process the shipping information and generate a return shipping label, generating the return shipping label and providing the customer with access to the return shipping label.

In accordance with yet another embodiment of the present invention, a system for a merchant to electronically provide a return shipping label to a customer that wishes to return a good is disclosed and comprises a merchant server, hosting a merchant website and capable of communicating with an application service provider and at least one customer computer, an application service provider computer in communication with the merchant server, an application service provider application, residing on the application service provider server that is configured to generate a return shipping label based at least in part on the shipping information received from the merchant server, and a customer computer for receiving a return shipping label.

### BRIEF DESCRIPTION OF THE DRAWINGS

Having thus described the invention in general terms, reference will now be made to the accompanying drawings, which are not necessarily drawn to scale, and wherein:

FIG. 1 is a high-level block diagram that illustrates a typical return process used in the prior art.

FIG. 2 is a high-level block diagram of an electronic return system in accordance with an embodiment of the present invention.

FIG. 3 is a high-level block diagram that illustrates the operation of an electronic return system in accordance with an embodiment of the present invention.

FIGS. 4A-4F show the type of web pages that a merchant might use in accordance with an embodiment of the present invention to permit a customer to submit an electronic return request.

FIG. 5 illustrates a typical electronic return shipping label that is generated and sent to a customer in accordance with an embodiment of the present invention.

FIG. 6 illustrates a webpage that includes a return shipping label and other text related to the return in accordance with an embodiment of the present invention.

FIG. 7 illustrates a webpage that lists carrier drop off locations in accordance with an embodiment of the present invention.

FIG. 8 illustrates a webpage of a map that details the location of a particular carrier drop off location.

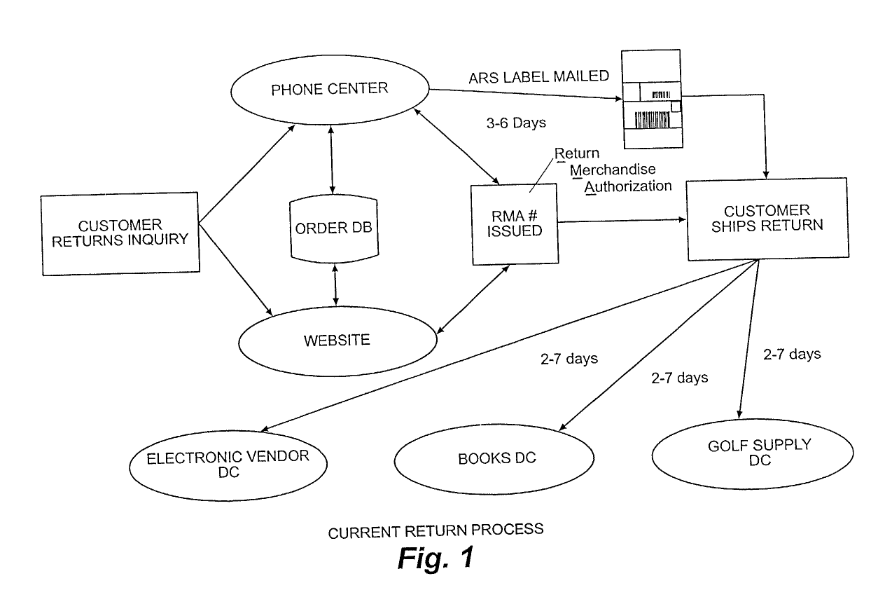

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The following paragraphs describe the present invention within an Internet environment. This is for illustration purposes only. It will be readily apparent to one or ordinary skill in the art that the present invention can be applied in any network environment.

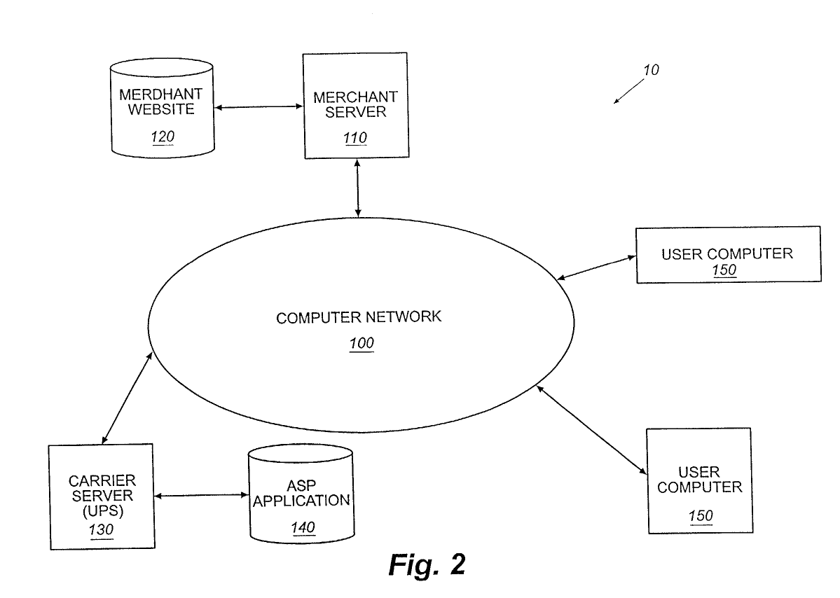

FIG. 2 is a high-level block diagram of a merchant electronic return system 10 for practicing various aspects of the present invention. The present invention includes a merchant server 110 in communication with the computer network 100 and a website 120 associated with the merchant server 110. The merchant server 110 generates and stores information that can be accessed by other computers on a computer network 100. In a preferred embodiment, the information is stored as webpages and accessed via the World Wide Web using web browsers that are well known in the art.

The present invention also includes a carrier server 130 in communication with the computer network 100 and the merchant server 110. FIG. 2 shows a carrier server 130 operated by United Parcel Service (UPS). The present invention however is not limited to UPS servers and the carrier server 130 may be owned or operated by another carrier or by any other entity. For that reason, the carrier server 130 is sometimes generically referred to herein as an Application Service Provider (ASP). The carrier server 130 includes an ASP application 140 (the operation of which is described below) which, in accordance with the present invention, processes the shipping information received from the merchant server 110 to generate return shipping labels.

Again with reference to FIG. 2, the present invention includes at least one user computer 150 in communication with the computer network 100 and the merchant server 110. In a preferred embodiment, a user computer 150 is equipped with a web browser capable of accessing the merchant website 120.

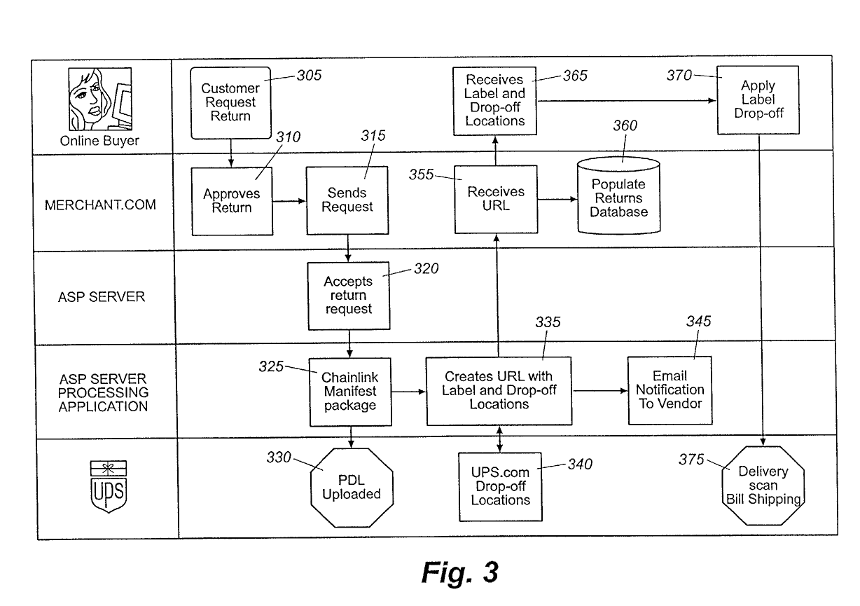

FIG. 3 is a high-level block diagram that sets forth the operation of an embodiment of the present invention. In Step 305, a user accesses a merchant website 120 and submits a return request, wherein the user notifies the merchant that a customer wishes to return a good. In a preferred embodiment, the user is the customer that wishes to return the good and the customer uses a user computer 150 to contact the merchant website 120. But it should be readily apparent that the user accessing the merchant website 120 does not have to be the customer. In an alternative embodiment, for example, the user is a customer service representative that works for the merchant and enters the return request on behalf of a customer after receiving a telephone call or email message from a customer.

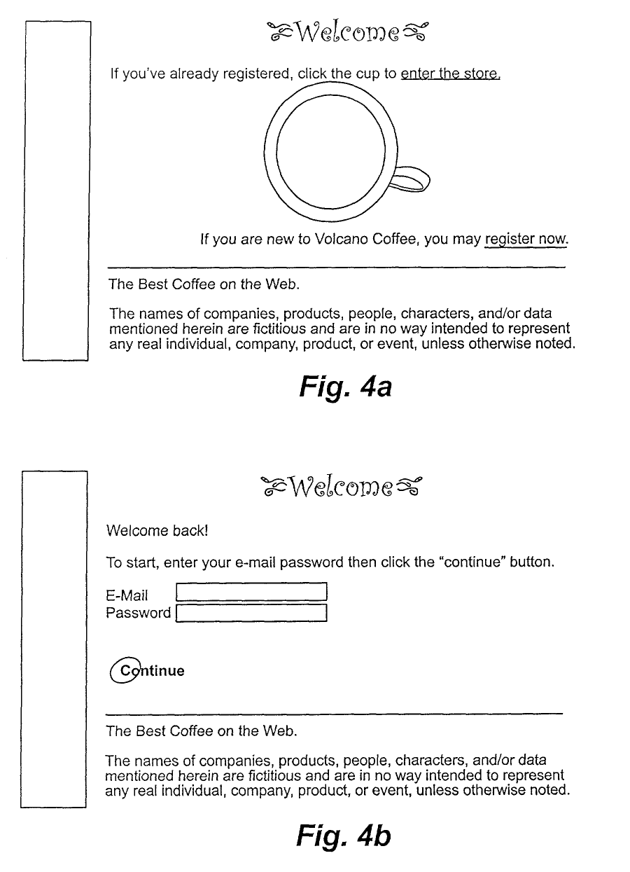

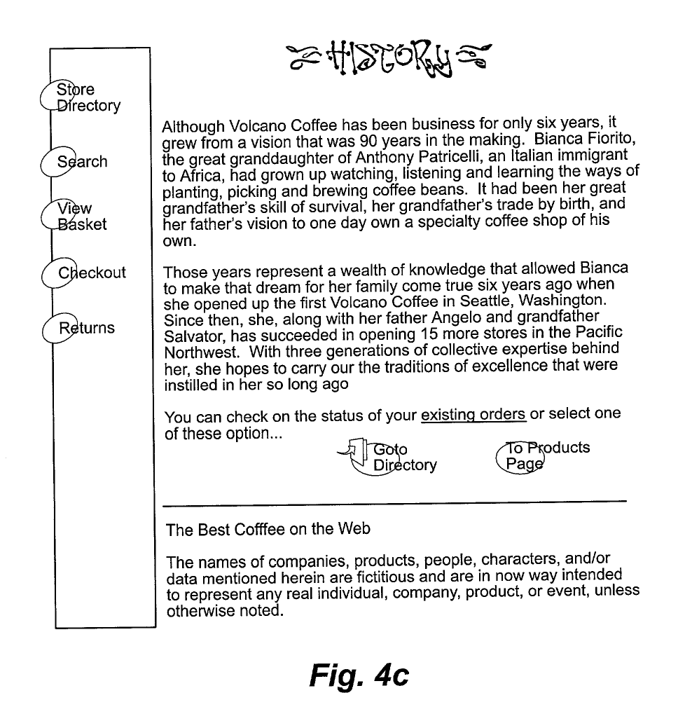

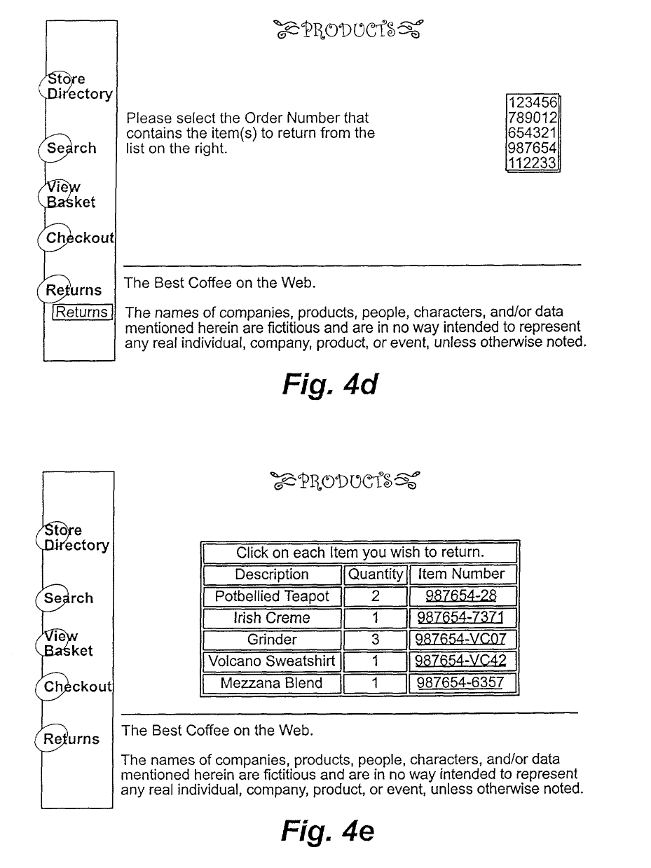

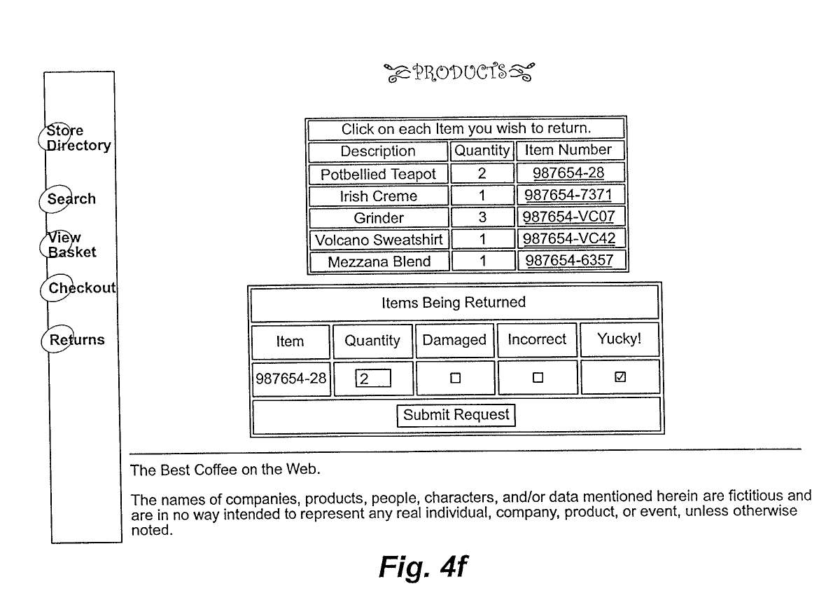

FIGS. 4A-4F illustrate webpages that a merchant might provide in accordance with the present invention to permit a user to submit a return request. The home page shown in FIG. 4A illustrates a typical entry point to a merchant website 120. In a preferred embodiment, the home page identifies the merchant and offers users the option to enter the site or register as a new user. FIG. 4B is an example login web page that identifies the user by email address and password. When the user logs on, the merchant system links the user to a directory page of the merchant website, such as exemplified in FIG. 4C. From the directory page, the user may select from the panel of options on the left of the page. In a preferred embodiment, the options include “Store Directory,” “Search,” “View Basket,” “Checkout” and “Returns” and each option has a corresponding hypertext link that directs the user to a corresponding webpage.

To submit a return request, the user selects the “Return” option and is linked to a webpage such as that shown in FIG. 4D. The webpage shown in FIG. 4D displays a list of orders that the customer has previously placed with the merchant and allows the user to select the order that corresponds to the item that the customer wishes to return. In the preferred embodiment, the customer order list is stored in a customer order database and is indexed by a customer identifier. Thus, when the user selects the “Return” option from the directory page, the system automatically retrieves and displays the customer order list that corresponds to that user. The customer order list shown in FIG. 4D identifies the item that the customer wishes to return. It will be readily apparent to one of ordinary skill in the art that using a customer order list is but one of many methods for identifying the good that the customer wishes to return. In an alternative embodiment, for example, a user may be prompted to input the relevant product information.

Continuing with this illustration, the user next selects a order number that corresponds to the item that the customer wishes to return. The user's selection of an order number causes the user to be linked to a webpage such as shown in FIG. 4E where a product table that lists the product items corresponding to the selected order number is displayed. The product table shown in FIG. 4E lists the description, quantity and item number for each item that corresponds to the selected order number. The product table fields shown in FIG. 4 are intended to be illustrative. In alternative embodiments, a product table may include such additional information as purchase price, retail price, color and weight.

In the next step, the user selects the item to be returned from the product table by clicking a hypertext link that corresponds to the appropriate item number. In this example, a user wishes to return a Potbellied Teapot and therefore selects the hypertext link for item number 987654-28. This link sends the user to FIG. 4F where the user is queried to identify the quantity of Potbellied Teapots that the customer wishes to return. The user is also given the opportunity to select one of a list of pre-approved reasons for the return. Three pre-approved reasons for return are shown in FIG. 4F: “damaged,” “incorrect,” and “yucky!” In a preferred embodiment, the customer return request is preapproved and occurs instantaneously. In an another embodiment, a merchant may elect to review the reasons for the return request before approving the return, or alternatively, may skip the approval process entirely. And it will be readily apparent that a merchant's approval process may occur instantaneously or the return process may be halted pending additional acts from the merchant or customer.

Returning to the block-diagram of FIG. 3, the merchant approval process is shown in Step 310. Once the return request is approved, the process proceeds to Step 315, in which the merchant server 110 (see also FIG. 2) establishes a link with the ASP server 130 via the computer network 100 and transmits shipping information related to the customer return request. The shipping information may include any information a carrier uses to ship a package from a customer to a merchant, including without limitation, the customer address, merchant address, service level and the weight and dimensions of the package to be shipped. In a preferred embodiment, the merchant server 110 obtains the customer address from the customer order database and obtains information about the dimensions and weight of the item being shipped from one or more product databases. In an alternative embodiment, the customer, the merchant or a third-party vendor may input some or all of the shipping information. If a product database is used, it may reside on the merchant server 110 or may reside on a separate server such as a third-party supplier or vendor server (not shown).

In Step 320 of FIG. 3, the ASP server receives the return request and related shipping information and proceeds to Step 325 where the transaction is manifested. In Step 325, the shipping information is validated against the shipping rules of the carrier. If necessary shipping information is missing, or alternatively, if an inappropriate carrier service level is requested, an error code is generated and sent to the merchant. An illustration of an inappropriate carrier service level request is a request for ground service for a delivery from California to Hawaii. If the system determines that the transaction is valid, the ASP server sends the shipping information to the carrier server (Step 330). In a preferred embodiment, the shipping information is sent to the carrier in a record format known as package level detail (PLD). But it will be readily apparent to one of ordinary skill in the art that the shipping information may be sent to the carrier in any format. In a preferred embodiment, in Step 330 the carrier initiates the billing process and generates a bill to the merchant for the shipping charges. And the carrier assigns a package tracking number to the transaction and transmits the tracking information to the ASP server.

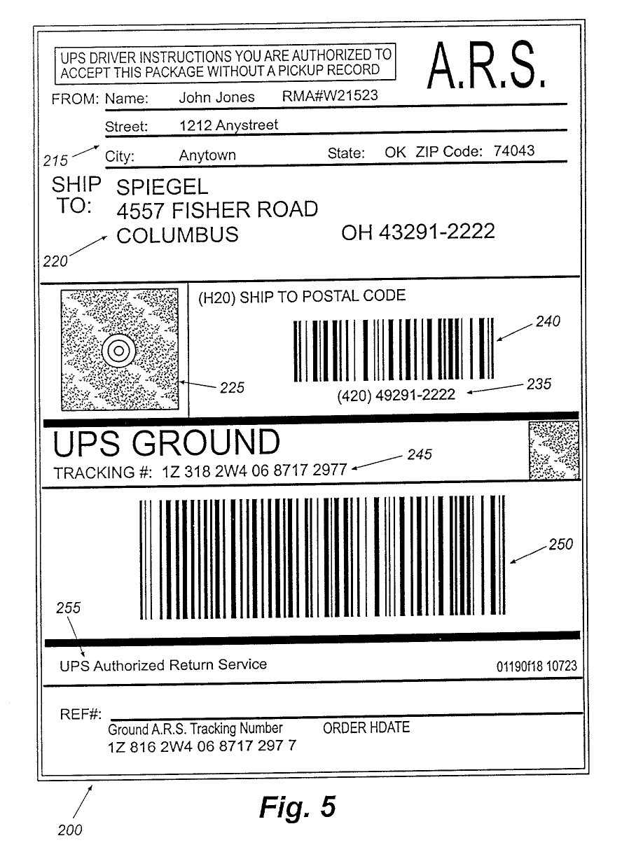

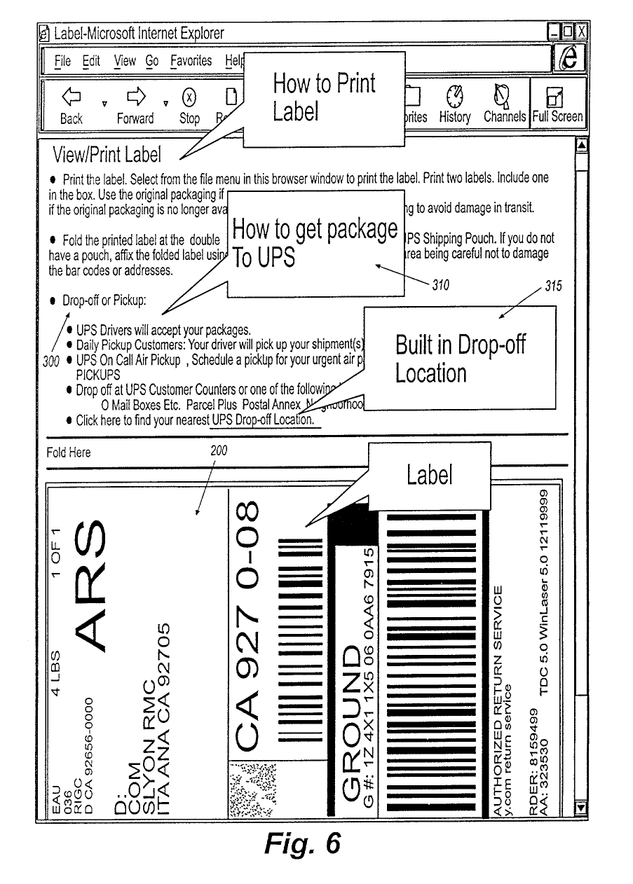

In Step 335, the ASP application uses the shipping information from the merchant and the tracking information from the carrier to generate an electronic return shipping label. In one embodiment, ASP application creates a webpage in Hyper Text Markup Language (HTML) format that displays the electronic image of the return shipping label and assigns the webpage a Uniform Resource Locator (URL) address. FIG. 5 illustrates a typical return shipping label 200 and includes: a ship from address 215, ship to address 220, Maxicode™ 225, post office code 235, post office bar code 240, carrier tracking number 245, carrier bar code 250, and service identification 255. In the preferred embodiment, the ship from address 215 is the address of the customer and the ship to address 220 is the address of the merchant or vendor that accepts delivery of the returned item.

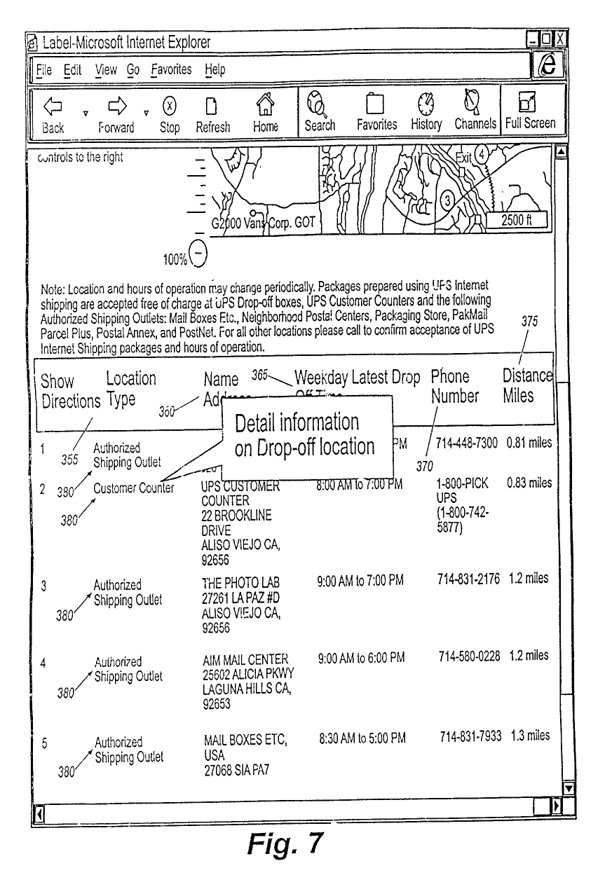

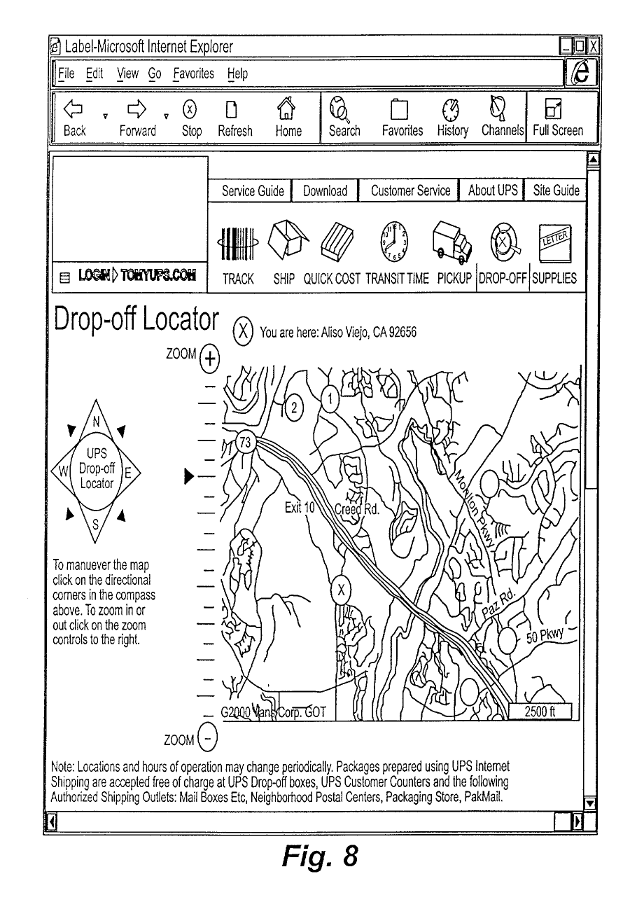

FIG. 6 shows another embodiment of a webpage created by the ASP application in Step 355. In this embodiment, a text area 300 accompanies the shipping label 200 and the text area 300 includes written instructions about printing a label 305 and taking a package to a carrier for shipment 310. The text area 300 also includes a carrier drop off locator link 315. A click on the drop off locator link 315 causes the ASP application to access a carrier drop off database and retrieve a list of carrier drop off locations that are near the customer address. In a preferred embodiment, the ASP application retrieves carrier drop off locations within ten miles of the customer address. FIG. 7 shows a typical webpage that is displayed when a user clicks on the drop off locator link 315. The webpage shown in FIG. 7 lists carrier drop off locations 350 that are near the customer address 215. A location type 355, address 360, hours of operation 365, telephone number 370 and distance from the customer's address 375 is displayed for each drop off location. In addition, a drop off link 380 is shown that will provide detailed information about each drop off location when selected. In one embodiment, this detailed information includes a map from the customer address 215 to the drop off location (FIG. 8).

Returning to FIG. 3, after the ASP application creates the website that displays the return shipping label, the process proceeds to Step 345 and the ASP application transmits an email notification to a vendor indicating that an good is being returned. In a preferred embodiment, this step only occurs if the good that is being returned is not being shipped directly to the merchant but is instead being shipped to a third-party vendor or supplier of the good. Alternatively, Step 345 might provide an email notification to another division of the merchant or another entity that the merchant uses to process returns.

In Step 355, the ASP application sends the URL address of the return shipping label webpage to the merchant server 110. In a preferred embodiment, the webpage is actually stored on the ASP server and a link to the URL address is sent to the merchant server 110. Alternatively, the ASP application may send the actual return shipping label HTML document and allow the merchant publish the page on the merchant server 110. In either of these embodiments, the merchant is responsible for providing the customer with the URL address of the webpage containing the return shipping label.

In alternative embodiments, the ASP application sends the return shipping label directly to the customer. In one embodiment, the ASP application sends an email to the customer that includes the URL address of the webpage containing the return shipping label. In another embodiment, the ASP application may format the return shipping label as a graphical file and may attach the graphical file to an email to the customer. In a preferred embodiment, the image of a return shipping label is formatted as a portable data file (PDF), but it will be readily apparent to one of ordinary skill in the art that an image of a return shipping label may be stored in other data formats such as a portable network graphic (PNG) or graphics interchange format (GIF).

In yet another embodiment, the customer does not receive a return shipping label. Instead, the ASP application generates a return shipping label and transmits it directly to a carrier facility that is near the customer's address. In this embodiment, the carrier sends a driver to pick up the package from the customer rather than requiring that the customer take the package to a carrier drop off facility. The ASP application accomplishes this by accessing a carrier facility database (not shown) to determine which carrier facility is responsible for deliveries to the customer address. The ASP application then generates a return shipping label and transmits it directly to the local carrier facility. A driver from the carrier facility then takes the return shipping label to the customer address, picks up the package to be returned, affixes the shipping label to the package and places the package in the carrier's shipping system for delivery to the merchant.

Returning to the embodiment illustrated in FIG. 3, in Step 360 the merchant updates its database records in response to a notification from the ASP application that a return shipping label was generated for the return transaction. The merchant's updates to the database may include general statistics relating to products returns as well as specific details about the particular transaction such as package tracking numbers, return shipment costs and product inventory updates.

In Step 365, the customer receives the return shipping label and drop off location information. In FIG. 3, the merchant sends the customer the URL address of the website that contains the shipping label and drop off information. However, as discussed above, in alternative embodiments the customer may receive the return shipping label directly from the ASP application or a carrier may send a driver to the customer's address as part of a carrier pick up service.

In Step 370, the customer prints the return shipping label, affixes the label to a package containing the item to be returned and takes the package to a carrier drop off location. And in Step 375, the carrier receives the package and delivers it to the ship to address specified on the return shipping label. In a preferred embodiment, the carrier tracks the package throughout the delivery process using the package tracking number on the return shipping label and bills the merchant or other appropriate party for the shipping fee upon confirmation of delivery. In the preferred embodiment, the package tracking number provides the confirmation of delivery and triggers the billing process. Further, multiple billing options are available and a merchant may be billed via credit card, check or an account debit.

In concluding the detailed description, it should be noted that it will be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

That which is claimed:

1. A method for a merchant to provide an electronic return shipping label to a customer to allow said customer to return goods, comprising the steps of:
receiving a return request for said goods from said customer;
obtaining shipping information related to said return request; and
electronically providing said customer with said return shipping label that can be printed and affixed to a package for returning said goods.

2. The method of claim 1, wherein receiving a return request for said goods from said customer comprises said customer submitting said return request through a merchant website associated with a merchant server.

3. The method of claim 1, wherein receiving a return request for said goods from said customer comprises said customer contacting a representative of said merchant and said representative submitting said return request through a merchant website associated with a merchant server.

4. The method of claim 1, wherein said shipping information related to said return request comprises a customer address and information related to the size and weight of said goods that are being returned.

5. The method of claim 1, wherein at least a portion of said shipping information related to said return request is obtained from a customer order database.

6. The method of claim 1, wherein at least a portion of said shipping information related to said return request is obtained from a product database.

7. The method of claim 1, wherein said electronic return shipping label is formatted as an HTML document.

8. The method of claim 7, wherein electronically providing said customer with said return shipping label that can be printed and affixed to a package for returning said goods comprises providing said customer with a URL address that corresponds to said return shipping label.

9. The method of claim 1, wherein electronically providing said customer with said return shipping label that can be printed and affixed to a package for returning said goods comprises providing said customer with a file containing an electronic image of said return shipping label.

10. The method of claim 1, further comprising the step of said merchant authorizing said return request.

11. The method of claim 1, wherein electronically providing said customer with said return shipping label comprises sending said return shipping label to a carrier with instructions to pick up said goods from said customer.

12. A method for a merchant to provide an electronic return shipping label to a customer to allow said customer to return goods, comprising the steps of:
receiving a return request for said goods from said customer;
obtaining shipping information related to said return request;
transmitting said shipping information to an application service provider, said application service provider configured to process said shipping information and generate said return shipping label;
generating said return shipping label at said application service provider; and
providing said customer electronic access to said return shipping label.

13. The method of claim 12, receiving a return request for said goods from said customer comprises said customer submitting said return request through a merchant website associated with a merchant server.

14. The method of claim 12, wherein receiving a return request for said goods from said customer comprises said customer contacting a representative of said merchant and said representative submitting said return request through a merchant website associated with a merchant server.

15. The method of claim 12, wherein at least a portion of said shipping information related to said return request is obtained from a customer order database.

16. The method of claim 12, wherein at least a portion of said shipping information related to said return request is obtained from a product database.

17. The method of claim 12, wherein said electronic return shipping label is formatted as an HTML document.

18. The method of claim 17, wherein electronically providing said customer with said return shipping label that can be printed and affixed to a package for returning said goods comprises providing said customer with a URL address that corresponds to said return shipping label.

19. The method of claim 12, wherein electronically providing said customer with said return shipping label that can be printed and affixed to a package for returning said goods comprises providing said customer with a file containing an electronic image of said return shipping label.

20. A system for a merchant to electronically provide a return shipping label to a customer that wishes to return goods, comprising:
a merchant server, hosting a merchant website and capable of communicating with an application service provider server and at least one customer computer;
an application service provider server in communication with said merchant server;
an application service provider application, residing on said application service provider server configured to generate said return shipping label based at least on part on shipping information received from said merchant server; and
a customer computer for receiving said return shipping label.
